(19) United States
(12) Patent Application Publication
(10) Pub. No.: US 2004/0266355 A1
(43) Pub. Date: Dec. 30, 2004

(54) METHOD FOR ELIMINATING IRRITATING NOISE AT THE END OF COMMUNICATION FOR A WALKIE TALKIE

(76) Inventors: Jany-Yee Hsu, Yun-Lin Hsien (TW); Ming-Hui Chen, Chang-Hua Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,094

(22) Filed: Jun. 26, 2003

(51) Int. Cl. H04B 1/00; H04B 7/00; H04B 17/00

(52) U.S. Cl. 455/67.11; 455/68; 455/70; 455/63.1

(57) ABSTRACT

A method of eliminating irritating noise at the end of communication for a walkie-talkie which has a receiving loop. The method includes providing a first detector, determining whether a radio frequency signal in a predetermined frequency range received by the walkie-talkie belongs to a non-standard squelch signal by using the first detector, and if so, stopping the walkie-talkie from receiving subsequent radio frequency signals.

### BACKGROUND OF INVENTION

1. Field of the Invention

The present invention relates to a method of preventing from generating noise for a walkie-talkie, more specifically, to a method of preventing noise at the receiving end at the moment of the end of conversation.

2. Description of the Prior Art

A continuous tone-coded squelch system (CTCSS) has been widely applied to wireless transmission, and is used to let a plurality of users communicate with each other within a predetermined communication area. The CTCSS adopts a low-frequency CTCSS tone signal to distinguish signals transmitted via the same physical channel. For instance, a prior art walkie-talkie utilizes the CTCSS to achieve group communication. Please refer to FIG. 1, which is a schematic diagram showing frequency bands used by the prior art CTCSS. As shown in FIG. 1, a band ranging from 62.5 Hz to 250 Hz is used to transmit the above-mentioned low-frequency CTCSS tone signal, and another band ranging from 300 Hz to 3.4 KHz is used to transmit speech signals spoken by a user. The operation of the CTCSS is described as follows. With regard to the prior art walkie-talkie, 14 channels P₁-P₁₄ generally are adopted to carry signals, and the 14 channels are physical channels. In addition, 38 CTCSS tone signals T₁-T₃₈ individually corresponding to different frequencies are used. One of the 38 CTCSS tone signals T₁-T₃₈ annexed to one physical channel generates a specific logical channel, and the 14 physical channels are capable of forming 532 (14*38) logical channels in total. When a speaker sets the walkie-talkie with a physical channel P₁ and a desired CTCSS tone signal T₁, the logical channel set by the speaker becomes P₁ (T₁). After the speaker presses a push-to-talk (PTT) button on the walkie-talkie, the speaker is capable of outputting speech signals via the walkie-talkie toward the predetermined communication area specified by the walkie-talkie. If there are three listeners in the predetermined communication area, and the three listener set their own logical channels as P₁ (T₁), P₁ (T₃₈), P₂ (T₁) respectively. For the first listener with a logical channel P₁ (T₁), because his walkie-talkie receives and transmits signals through the physical channel P₁, the walkie-talkie of the first listener will start receiving speech signals spoken by the speaker. In addition, the walkie-talkie of the first listener judges that the CTCSS tone signal used by the speaker is T₁. In other words, the speaker and the first listener both adopt the same logical channel P₁ (T₁). Therefore, the walkie-talkie of the first listener then outputs the received speech signals via an audio speaker. The first listener is capable of hearing the speech signals spoken by the speaker. For the second listener with a logical channel P₁ (T₃₈), because his walkie-talkie receives and transmits signals through the physical channel P₁, the walkie-talkie of the second listener will start receiving speech signals spoken by the speaker. However, the walkie-talkie of the second listener judges that the CTCSS tone signal used by the speaker is not T₁, but T₃₈. In other words, the speaker and the second listener adopt different logical channels P₁ (T₁) and P₁ (T₃₈). Therefore, the walkie-talkie of the second listener then does not output the received speech signals via an audio speaker, and the second listener cannot hear the speech signals spoken by the speaker. For the third listener with a logical channel P₂ (T₁), because his walkie-talkie receives and transmits signals through the physical channel P₂, the walkie-talkie of the third listener and that of the speaker use different physical channels. With the unmatched physical channel, the walkie-talkie of the third listener cannot acknowledge an adequate signal strength indicated by a received signal strength indicator (RSSI). Therefore, the walkie-talkie of the third listener will not receive any speech signals spoken by the speaker. That is, no speech signal is played by an audio speaker of the walkie-talkie. The second and third listeners cannot hear any speech signals spoken by the speaker, that is, the walkie-talkies of the second and third listeners both detect the CTCSS tone signal related to the received speech signals for actuating a signal squelch function. To sum up, only the users using the same logical channel can communicate with each other to achieve group communication.

Please refer to FIG. 2, which is a block diagram of a prior art walkie-talkie 10. The walkie-talkie 10 has an antenna 11, a transceiver 12, a selector 14, a processor 16, a speaker 17, a microphone 18, and a speech signal processor 20. The walkie-talkie 10 can receive and transmit radio frequency (RF) signals through the antenna 11. With regard to receiving RF signals, the transceiver 12 converts the high-frequency RF signal into a low-frequency baseband signal Rx, and transmits the baseband signal Rx to the selector 14. The selector 14 then outputs the baseband signal Rx from an output port A. The processor 16 determines frequency of a CTCSS tone signal according to the received baseband signal Rx. Generally speaking, the processor 16 has a low-pass filter (LPF) for extracting signals with frequencies ranging from 62.5 Hz to 250 Hz, and then the processor 16 judges the CTCSS tone signal related to the baseband signal Rx to decide whether the walkie-talkie 10 and the baseband signal Rx use the same logical channel. If the walkie-talkie 10 and the baseband signal Rx use the same logical channel, the processor 16 activates the speaker 17 to proceed following signal output operation. That is, the speech signal processor 20 has two analog filter circuits for extracting signals with frequencies ranging from 300 Hz to 3.4 KHz, and the extracted signals are played by the speaker 17. On the contrary, if the walkie-talkie 10 and the baseband signal Rx use different logical channels, the processor 16 does not actuate the speech signal processor 20 and the speaker 17. The walkie-talkie 10, therefore, does not output any speech signals transmitted by unmatched logical channels. With regard to transmitting RF signals, when the user presses the PTT button, the selector 14 will chose the input port B, and the processor 16 simultaneously actuates the microphone 18. Therefore, the speech signals spoken by the user are inputted into the speech signal processor 20. As mentioned above, the speech signal processor 20 uses filter circuits to extract signals with frequencies ranging from 300 Hz to 3.4 KHz, and the speech signal processor 20 outputs the extracted signals to the CTCSS encoder 18. Based on a CTCSS code (CTCSS tone signal with a specific frequency) set in the walkie-talkie 10, the processor 16 adds a corresponding CTCSS tone signal in the extracted signals outputted from the speech signal processor 20 for forming a baseband signal Tx. In the end, the transceiver 12 converts the low-frequency baseband signal Tx into a high-frequency RF signal, and the RF signal is then outputted via the antenna 11.

Theoretically, during receiving RF signal, while the RSSI at the receiving end is higher than a receivable threshold, the speaker 17 is turned on, on the contrary, while the RSSI is lower than the receivable threshold, the speaker 17 is turned off. At the moment of end of communication, that is, the moment of releasing the PTT, the RF signal is thus terminated to transmit. However, in the course of the strength of receiving signal going from receivable to unreceivable, the transceiver 12 is still in receiving state, meanwhile the speaker 17 is still turned on. Therefore, the noise whose transient strength may be higher than the receivable threshold is demodulated and outputted by the speaker 17 to generate an irritating noise to make the user uncomfortable.

### SUMMARY OF INVENTION

It is therefore a primary objective of the claimed invention to provide a method used in a walkie-talkie for preventing from generating an irritating noise at the moment of the end of conversation to solve the aforementioned problem.

Briefly summarized, the claimed invention provides a method for a walkie-talkie having a receiving loop comprising the steps of providing a first detector; determining whether a non-standard CTCSS tone signal in a predetermined frequency range is included in a radio frequency signal received by the walkie-talkie by using the first detector; and stopping receiving subsequent radio frequency signals if the non-standard CTCSS tone signal in the predetermined frequency range is included in the radio frequency signal.

These and other objectives of the claimed invention will no doubt become obvious to those of ordinary skill in the art after reading the following detailed description of the invention, which is illustrated in the various figures and drawings.

### BRIEF DESCRIPTION OF DRAWINGS

FIG. 1 is a schematic diagram showing frequency bands used by the prior art CTCSS.

FIG. 2 is a block diagram of a prior art walkie-talkie.

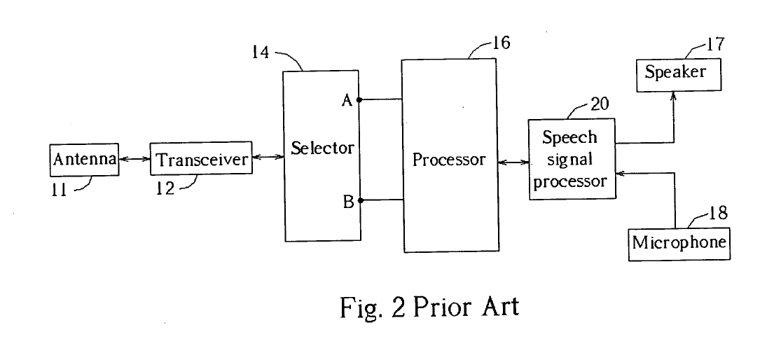

FIG. 3 is a schematic diagram of walkie-talkies according to the present invention.

FIG. 4 is a block diagram of the walkie-talkies according to the present invention.

FIG. 5 is a timing diagram at transmission end depicted in FIG. 4.

FIG. 6 is an operation flowchart with respect to the walkie-talkie according to the present invention.

### DETAILED DESCRIPTION

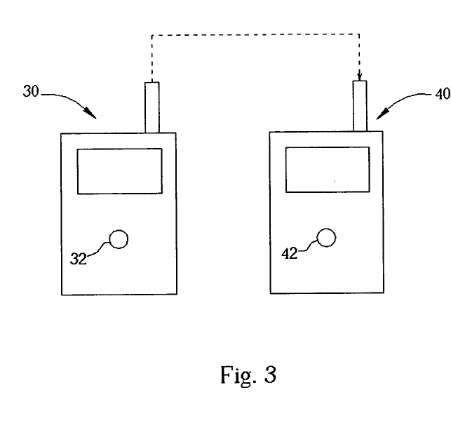

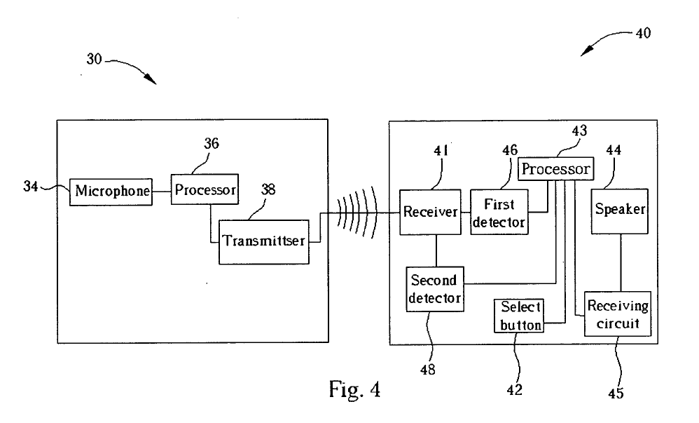

Please refer to FIGS. 3, 4, and 5. FIG. 3 is a schematic diagram of the walkie-talkies 30, 40 according to the present invention. FIG. 4 is a block diagram of the walkie-talkies 30, 40 according to the present invention.

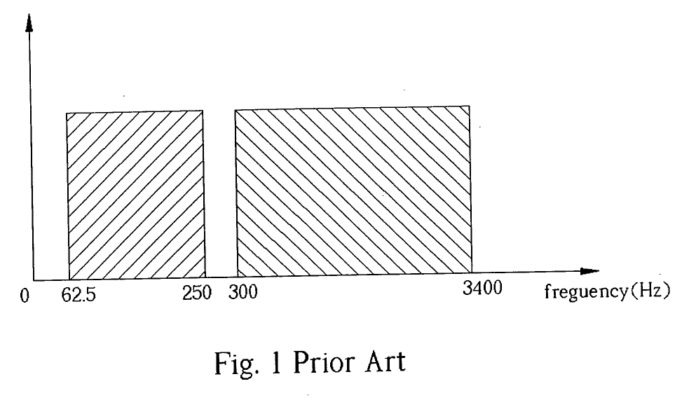

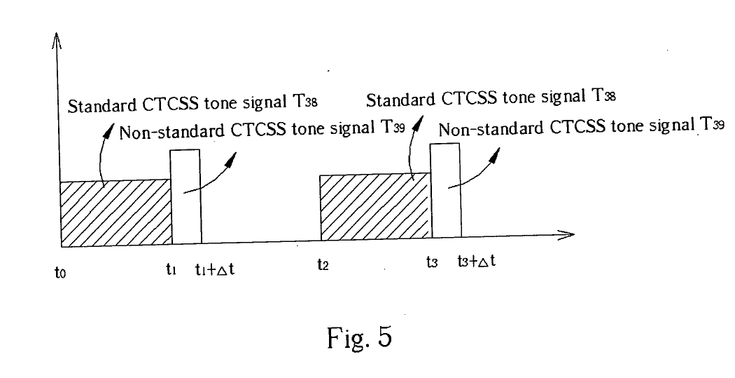

FIG. 5 is a timing diagram at transmission end depicted in FIG. 4. The walkie-talkie 30 comprises a push-to-talk (PTT) button 32, a microphone 34, a processor 36, and a transmitter 38. The walkie-talkie 40 comprises a receiver 41, a select button 42, a processor 43, a speaker 44, a first detector 46, a second detector 48, and a receiving loop 45. When pressing the PTT button 32 (time at t₀ shown in FIG. 5), the processor 36 activates the microphone 34 to receive a speech signal, which is converted from human sound or ambient sound, and generates a standard CTCSS tone signal according to a predetermined frequency. Finally, the speech signal and the standard CTCSS tone signal T₃₈ both combining a predetermined carrier is broadcasted. For example, as shown in FIG. 1, since 38 channels corresponding to the standard CTCSS tone signals are distributed in the frequency range of 62.5 Hz-250 Hz, if the walkie-talkie 30 is set by using a logical channel P₁(T₃₈), i.e. using a physical channel P₁ carrier, and a 38^{th} standard CTCSS tone signal (given its frequency is 250 Hz), the speech signal is broadcasted by using the logical channel P₁(T₃₈). After releasing the PTT button 32, i.e. time at t₁ shown in FIG. 5, the speech signal and the standard CTCSS tone signal T₃₈ are not broadcasted with the predetermined carrier. However, in the meantime, a non-standard CTCSS tone signal T₃₉ is generated and is broadcasted with the carrier by the walkie-talkie 30 for an interval Î [symbol] . If the PTT 32 is pressed at time t₂ and released at time t₃, the non-standard CTCSS tone signal T₃₉ is generated and is broadcasted with the carrier by the walkie-talkie 30 for an interval Î [symbol] again. Notice that frequency range of the non-standard CTCSS tone signal is between 62.5 Hz-250 Hz but is not overlapping the frequency range used by the standard CTCSS tone. Since the standard CTCSS tone signal and the non-standard CTCSS tone signal belong to the same frequency range, for preventing error, while the standard CTCSS tone signal is being transmitted, the non-standard CTCSS tone signal fails to be transmitted.

The receiver 41 of the walkie-talkie 40 is used for receiving RF signal from the walkie-talkie 30. In the illustrative embodiment, the receiver 41 is set to receive the physical channel P₁ carrier. The select button 42 is used to determine whether to use the first detector 46 and the second detector 48, or only the second detector 48, the first detector 46 is used to determine whether the non-standard CTCSS tone signal T₃₉ is included in the RF signal received by the receiver 41. The second detector 48 is used to determine whether the standard CTCSS tone signal T₃₈ is included in the RF signal received by the receiver 41. The receiving loop 45 is used to transform the speech signal within the RF signal into sound waves. The speaker 44 is used for outputting the sound waves. For the following explanation, assume that frequency of the non-standard CTCSS tone signal T₃₉ is defined as 65 Hz, not used by any standard CTCSS tone signal, and frequency of the standard CTCSS tone signal T₃₈ is defined as 250 Hz.

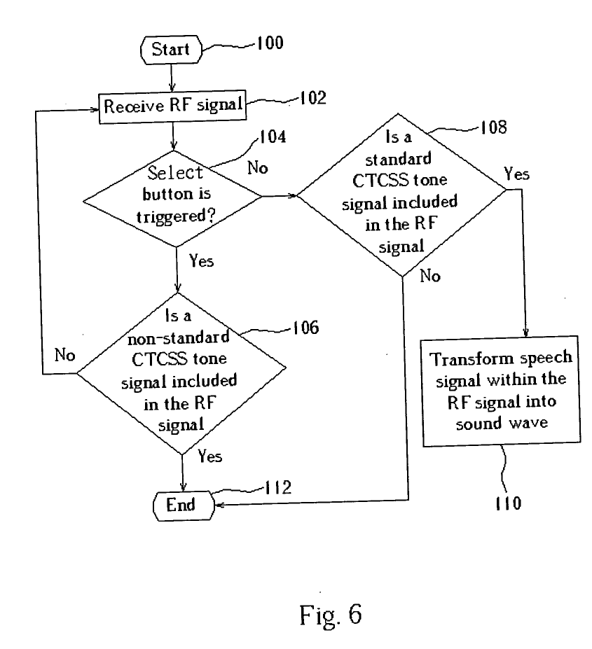

Please refer to FIG. 6, which shows an operation flowchart with respect to the walkie-talkie according to the present invention. The operation of the walkie-talkie 40 occurs as follows:

Step 100: start;

Step 102: the receiver 41 receives RF signal using the physical channel P₁;

Step 104: determine if the select button 42 is triggered? If it is, go to step 106; if not, go to step 108;

Step 106: determine whether the non-standard CTCSS tone signal T₃₉ is included in the RF signal by using the first detector 46. If it is, go to step 112, if not, go to step 102;

Step 108: determine whether the standard CTCSS tone signal T₃₈ is included in the RF signal by using the second detector 48. If it is, go to step 110, if not, go to step 114;

Step 110: deliver the RF signal to the receiving loop 45 to transform the speech signal within the RF signal into sound waves, and then use the speaker 44 to output the sound waves; and

Step 112: end.

After the receiver 41 receives the RF signal using the physical channel P₁ (step 102), if the select button 42 is pressed, the processor 43 controls the first detector 46 to detect whether the non-standard CTCSS tone signal T₃₉ is included in the RF signal received by the receiver 41, and controls the second detector 48 to detect whether the standard CTCSS tone signal T₃₈ is included in the RF signal received by the receiver 41. For example, assume that frequency for the non-standard CTCSS tone signal T₃₉ is 65 Hz (and the frequency does not belong to any defined standard CTCSS tone signals), when the select button 42 is pressed, the first detector 46 detects whether a 65 Hz signal is included within the RF signal (step 106), if the 65 Hz signal is detected, (i.e. time at t₁-t₁+Î [symbol] and t₃-t₃+Î [symbol] shown in FIG. 5), meaning that the PTT 32 of the walkie-talkie 30 is released, the walkie-talkie 40 stops receiving the subsequent RF signal. Since the walkie-talkie 40 stops receiving the RF signal, the speaker 44 also stops outputting the speech signal within the RF signal. If the 65 Hz is not detected, meaning that the walkie-talkie 40 is still under standby state (i.e. time at t₁+Î [symbol] −t₂), the walkie-talkie 40 keeps detecting the RF signal. If the select button 42 is not pressed, the processor 43 only controls the second detector 48 to detect whether the standard CTCSS tone signal T₃₈ with 250 Hz exists within the RF signal (step 108). If the standard CTCSS tone signal T₃₈ with 250 Hz exists (i.e. time t₀-t₁ and t₂-t₃ shown in FIG. 5), the processor 43 controls the receiving loop 45 to transform the speech signal with 300 Hz to 3.4 Khz into sound waves (step 110). Finally, the speaker 44 outputs the sound waves so that the user using the walkie-talkie 40 can listen to sound from the user using the walkie-talkie 30.

When the PTT 32 is pressed (time t₀-t₁, t₂-t₃ shown in FIG. 5), the transmitter 38 of the walkie-talkie 30 broadcasts the speech signal received by the microphone 34 and the standard CTCSS tone signal T₃₈ with 250 Hz. When the PTT 32 is released (time t₁-t₂ shown in FIG. 5), the transmitter 38 of the walkie-talkie 30 sends neither the speech signal received by the microphone 34 nor the standard CTCSS tone signal T₃₈ but the non-standard CTCSS tone signal T₃₉ with 65 Hz. Because the receiver 41 of the walkie-talkie 40 stops receiving the subsequent radio frequency signals when the receiving loop 45 receives the non-standard CTCSS tone signal T₃₉ with 65 Hz, hence, the walkie-talkie 40 can prevent from generating an irritating noise at the moment of the end of conversation.

In contrast to prior art walkie-talkie, when the conversation is finished, the walkie-talkie at the receiving end still receives white noise in air at the moment of turning off the speaker. Therefore the prior art speaker generates an irritating noise. Instead, the present invention walkie—sends a non-standard CTCSS tone signal T₃₉ at a later time, when the PTT is released. Then, the walkie-talkie turns off the speaker in the interval. By using such method, the speaker does not generate an irritating noise at the end of conversation.

Those skilled in the art will readily observe that numerous modifications and alterations of the method may be made while retaining the teachings of the invention. Accordingly, the above disclosure should be construed as limited only by the metes and bounds of the appended claims.

What is claimed is:

1. A method of eliminating irritating noise at the moment of the end of conversation for a walkie-talkie having a receiving loop, the method comprising:
providing a first detector;
determining whether a non-standard CTCSS tone signal in a predetermined frequency range is included in a radio frequency signal received by the walkie-talkie by using the first detector; and
stopping receiving subsequent radio frequency signals if the non-standard CTCSS tone signal in the predetermined frequency range is included in the radio frequency signal.

2. The method of claim 1 wherein the walkie-talkie comprises a second detector, the method further comprising:
using the second detector to detect whether a standard CTCSS tone signal in the predetermined frequency range is included in the radio frequency signal received by the walkie-talkie if the non-standard CTCSS tone signal in the predetermined frequency range is not included in the radio frequency signal; and
delivering the radio frequency signal to the receiving loop if the standard CTCSS tone signal in the predetermined frequency range is included in the radio frequency signal by using the second detector.

3. The method of claim 1 further comprising:
providing a select button; and
pressing the select button so that the radio frequency signal is capable of being transmitted to the first detector to detect.

4. The method of claim 1 wherein a frequency range of the non-standard CTCSS tone signal is between 62.5 Hz-250 Hz but is not overlapping the frequency range used by the standard CTCSS tone signal.

5. A walkie-talkie operating according to the method of claim 1.

6. A method for transmitting a radio frequency signal for a walkie-talkie, the walkie-talkie comprising a push-to-talk button, (PTT button), the method comprising:
outputting a standard CTCSS tone signal using the walkie-talkie when the PTT button is triggered; and
outputting a non-standard CTCSS tone signal using the walkie-talkie when the PTT button is released.

7. The method of claim 6 wherein a frequency range of the non-standard CTCSS tone signal is between 62.5 Hz-250 Hz but is not overlapping the frequency range used by the standard CTCSS tone signal.

8. A walkie-talkie operating according to the method of claim 6.
